(19) United States
(12) Patent Application Publication
(10) Pub. No.: US 2010/0196181 A1
(43) Pub. Date: Aug. 5, 2010

(54) Pump Device

(76) Inventor: Alizarov Zhobbar, Lawrenceville, GA (US)

Correspondence Address: Woodcock Washburn LLP, Cira Centre, 12th Floor, 2929 Arch Street, Philadelphia, PA, 19104-2891, US

(21) Appl. No.: 12/364,200

(22) Filed: Feb. 2, 2009

(51) Int. Cl. F04C 21/00; B23P 11/00

(52) U.S. Cl. 417/481; 29/888.02

(57) ABSTRACT

A pump that enhances the flow of liquids in a system according to the movement of one or more generally planar oscillating members within a fluid flow chamber, as directed by rotation of a simple crank member.

### FIELD

The present disclosure relates generally to liquid propulsion, and more particularly, to a pump device and liquid conveying method thereof.

### BACKGROUND

The enhanced flow of liquids is important in many applications. As such, numerous pumps have been described. Each, however, is disadvantageous in view of the presently described pump device.

Complicated coil spring structures draw liquid into a chamber to expel it through an impeller. Piston and valve systems necessitate interactively coordinated motion for delivery of forces transverse to the flow of fluid. Known centrifugal pumps and vane pumps, too, are disadvantageously complex. And, lobe pumps that have been described require a chamber that is free from dead space or cease to function in the presence of solid matter in the liquid.

Therefore, it is readily apparent that there is a need for a pump device and liquid conveying method thereof that is uncomplicated and can be utilized in a plurality of applications, and wherein mechanical enhancement of liquid propulsion is facilitated according to a beneficial motion of one or more oscillating fin members mounted within a chamber, thereby avoiding the above-discussed disadvantages.

### BRIEF SUMMARY

Briefly described, in a preferred embodiment, the present pump device, and method thereof, overcomes the above-mentioned disadvantages and meets the recognized need for such a device by providing a pump that enhances the flow of liquids in a system according to the movement of one or more generally planar oscillating members within a fluid flow chamber, as directed by rotation of a simple crank member.

According to its major aspects and broadly stated, in its preferred form, the present device is a pump that directs improvement of fluid flow by converting oscillatory motion into flapping action of the internal plate, or internal plates, in such manner that fluid movement is enhanced.

More specifically, the present pump device preferably comprises a generally rectangular, hollow housing with adaptive endpieces for inline installation into essentially any application wherein the pumping of liquid is desired. As such, there is an inflow end and an outflow end. Proximate the inflow end, there is a U-shaped member rotationally mounted within the housing, extending transversely across the hollow interior thereof. Proximate the outflow end, there is a cross-support member mounted within the housing in a fixed manner, and extending transversely across the hollow interior of the housing.

A generally resilient and supple flap member extends lengthwise within the hollow interior of the housing, and having a width that extends transversely across the housing interior. The first end of the flap member is attached to the U-shaped member proximate the inflow end, and the second end of the flap member is attached to the cross-support member proximate the outflow end. The length of the flap member is preferably equivalent to the distance between the mount locations of the U-shaped member and the cross-support member, such that a flowing, supple motion is possible for the flap member in one position and an extended, motion free configuration is possible for the flap member in an opposing position.

That is, as the U-shaped member is rotated, the first end of the flap member travels along a circumferential path centered at the location on the housing where the U-shaped member rotationally mounted. The movement of the flap member at the first end, then, serves to enhance the flow of fluid through the chamber by initiating a flowing, supple motion that passes along the length of the flap member, directing fluid coincident with its passage. The U-shaped member may be connected to a spin-drive delivery tool in order to allow for high speed/fast pace movement of the rotational member, wherein the flow of the fluid may be controlled according to the pace of the spin-drive.

In another embodiment the pump device could be formed without a fixedly mounted support member proximate the out flow end. In such an embodiment, the flap member could be a generally rigid plate, yet with slight flexibility, wherein rotation of the U-shaped member could direct the first end of the plate-style flap member along a circumferential path, but the second end would remain untethered within the chamber, thereby allowing for a free, flipper/fin-type movement for enhancing the flow of fluid through the chamber.

In yet another embodiment, the pump device could be formed with an alternate fixedly mounted support member proximate the out flow end. In such an embodiment, the distal end of the flap member could be secured to one or more springs, wherein each coil spring could be fixedly engaged with and essentially perpendicular to the alternate mounted support member, thereby allowing for the flipper/fin-type movement of the flap member to be assisted by the extension and retraction of the spring for enhancing the flow of fluid through the chamber.

In still another embodiment, the pump device could be formed without the U-shaped rotational member, wherein an alternate rotational member could be defined by a pair of interconnected and inversely related U-shapes. In such an embodiment, two flap members could be included, with one flap member attached to each U-shape of the rotational member. As with the previous embodiment, the second end of the flap members, proximate the outflow end of the chamber, would remain free. Therefore, upon direction via the rotational member, the first end of each flap member continues to travel about a circumferential track, but the ends of the two flap members remain positioned 180° relative to one another. A collaborative flipper-kicking motion results from the movement of the dual flap members, serving to enhance the flow of fluid through the housing.

Thus, a feature and advantage of the present device is its ability to perform as a cost-effective, non-complex unit, suitable for deployment on essentially any liquid transfer system.

Another feature and advantage of the present device is its ability to perform as a manual pump device, as well as a power driven pump device.

Yet another feature and advantage of the present device is its ability to efficiently function to enhance the flow of liquids with a minimal plurality of component parts.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a top cross-sectional view of a pump, according to the preferred embodiment of the present device;

FIG. 2 is an end view of the device of FIG. 1, showing a view of the interior chamber of the housing of the pump from the inflow end;

FIG. 3A is a side cross-sectional view of the device of FIG. 1, showing the U-shaped bar in a first position and a first resulting configuration of the inner flap;

FIG. 3B is the side cross-sectional view FIG. 3A, showing the U-shaped bar in a second position and a second resulting configuration of the inner flap;

FIG. 3C is the side cross-sectional view FIG. 3A, showing the U-shaped bar in a third position and a third resulting configuration of the inner flap;

FIG. 3D is the side cross-sectional view FIG. 3D, showing the U-shaped bar in a fourth position and a fourth resulting configuration of the inner flap;

FIG. 4 a top cross-sectional view of a pump, according to an alternate embodiment of the present device;

FIG. 5A is a side cross-sectional view of the device of FIG. 4, showing the U-shaped bar in a first position and a first resulting position of the inner plate;

FIG. 5B is the side cross-sectional view FIG. 5A, showing the U-shaped bar in a second position and a second resulting position of the inner plate;

FIG. 5C is the side cross-sectional view FIG. 5A, showing the U-shaped bar in a third position and a third resulting position of the inner plate;

FIG. 5D is the side cross-sectional view FIG. 5A, showing the U-shaped bar in a fourth position and a fourth resulting position of the inner plate;

FIG. 6 is a top cross-sectional view of a pump, according to another alternate embodiment of the present device;

FIG. 7 is an end view of the device of FIG. 6, showing a view of the interior chamber of the housing of the pump from the inflow end;

FIG. 8A is a side cross-sectional view of the device of FIG. 6, showing the rotatable bar in a first position and a first resulting configuration of dual inner plates:

FIG. 8B is the side cross-sectional view FIG. 8A, showing the rotatable bar in a second position and a second resulting configuration of the dual inner plates;

FIG. 8C is the side cross-sectional view FIG. 8A, showing the rotatable bar in a third position and a third resulting configuration of the dual inner plates;

FIG. 9A a top cross-sectional view of a pump, according to an alternate embodiment of the present device; and

FIG. 9B is a side cross-sectional view of the device of FIG. 9A.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

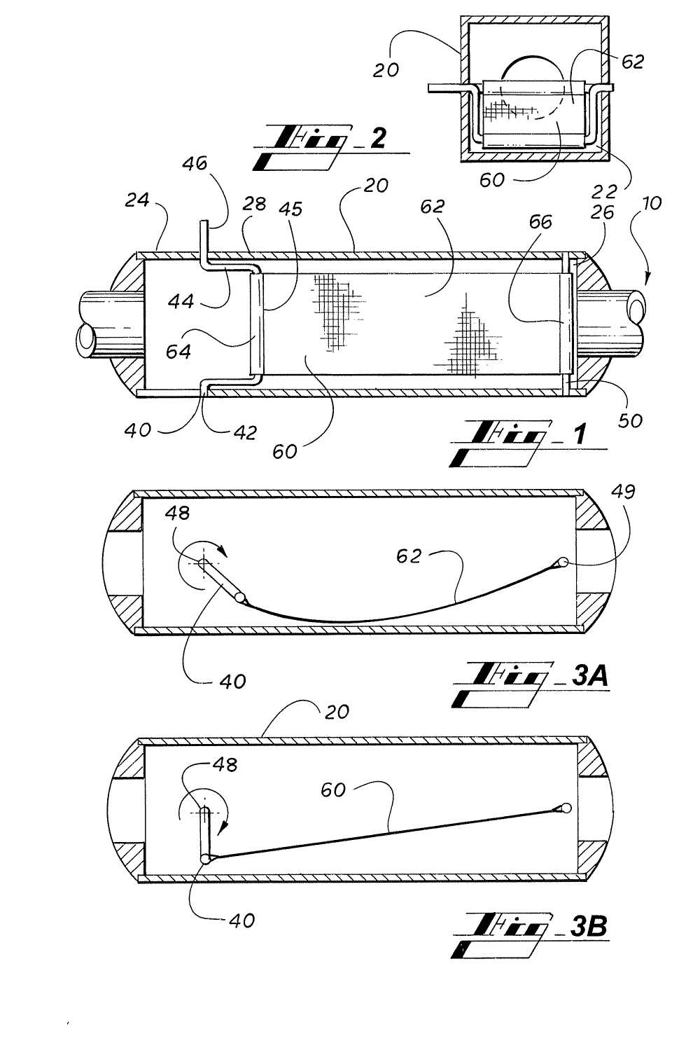

Referring now to FIGS. 1-3D, pump device 10 preferably comprises housing 20, rotationally mounted support member 40, and generally planar member 60. Preferably, housing 20 is prism-shaped, defining parallelepiped interior chamber 22. It should be noted that although particular endpieces are not shown, any one of a plurality of endpieces may be adaptively attached to inflow end 24 and/or outflow end 26 of housing 20 in order to facilitate inline installation of pump 10 into essentially any desired system. That is, without limitation, any type of adaptive endpiece may be fitted, welded, threadedly related, or otherwise suitably attached to housing 20 to enable secure and watertight installation of pump 10, as desired.

Rotationally mounted support member 40 preferably extends transversely across housing 20 proximate inflow end 24, defining U-shape 44 within housing interior chamber 22, and with at least one rotational arm 46 extending through peripheral wall 28 of housing 20. It should be recognized that while such a configuration is preferred, rotationally mounted support member 40 could have two rotational arms 46 opposingly extending outwardly through opposing peripheral walls 28 of housing 20, or, rotationally mounted support member 40 could have no rotational arm 46, wherein instead, a connection point (not shown) could be provided proximate peripheral wall 28 of housing 20 to facilitate attachment of an external handle or the like for transfer of rotational motion to U-shape 44. Additionally, according to the preferred embodiment, cross-support member 50 is attached proximate outflow end 26 of housing 20, extending transversely across interior chamber 22 of housing 20, and preferably in a fixed position.

Generally planar member 60 is preferably resilient and supple flap member 62, extends lengthwise within hollow interior chamber 22 of housing 20, and has a width that extends transversely across housing interior 22, essentially approaching abutment with peripheral walls 28 in order to allow for particular control of liquid within interior chamber 22. First end 64 of flap member 62 is preferably attached to U-shape 44 of rotationally mounted support member 40 proximate inflow end 28, and second end 66 of flap member 62 is preferably attached to cross-support member 50 proximate outflow end 26. Preferably, the length of flap member 62 is essentially equal to the distance between mount 48 of rotationally mounted support member 40 and mount 49 of cross-support member 50.

Accordingly, as rotationally mounted support member 40 is rotated, U-shape 44 directs first end 64 of flap member 62 to travel along a circumferential path centered about mount 48. It is this movement of flap member 62, proximate first end 64, that serves to initiate a flowing, supple motion for flap member 62, which in turn serves to enhance the flow of liquid through chamber 22, preferably culminating in a generally forceful, resiliency snap-like movement as completion of the circumferential path is achieved and a new circumferential path is begun.

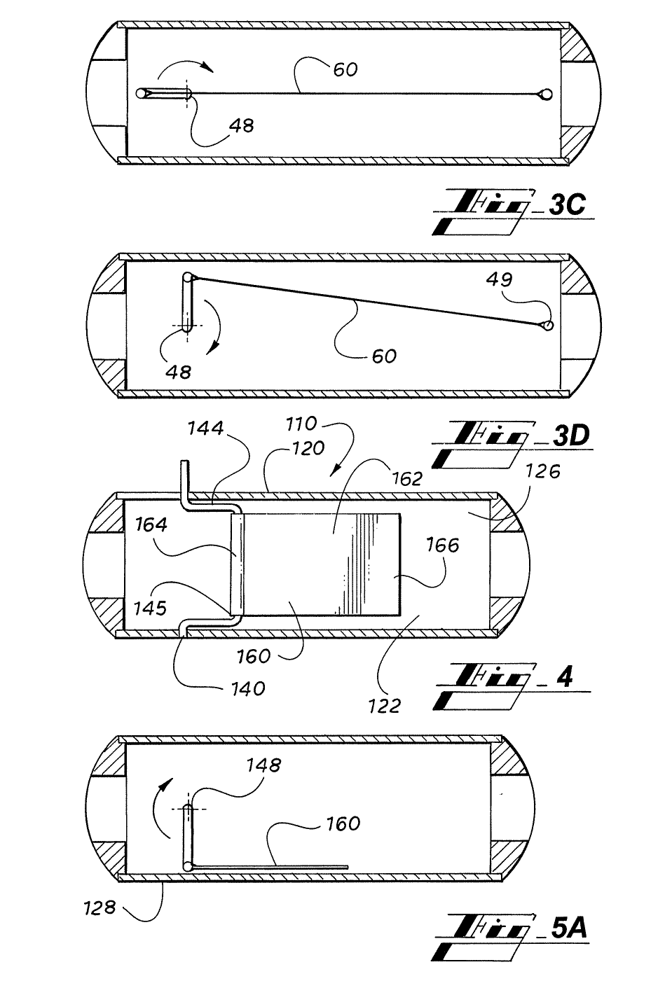

Accordingly, and with reference to FIG. 3A, for example, when U-shape 44 is rotated to a first position, wherein base 45 is partially rotated toward cross support member 50, flap member 62 is essentially slack within interior chamber 22. Upon continued advancement through a revolution of rotational support member 40, and with reference to FIG. 3B, a second position may be attained wherein base 45 is essentially perpendicular to peripheral wall 28, and wherein flap member 62 is generally flat and extended in an angular fashion relative to sidewalls 28 between mount 48 and mount 49. Upon further revolution of rotational support member 40, and with reference to FIG. 3C, a third position is achieved, wherein base 45 is essentially level along a line extending between mount 48 and mount 49, and wherein flap member 62 is generally stretched therebetween. As a result, resilience forces facilitate the efficient continuation of the pump motion, as the rotational motion proceeds to direct flap member 62 with a snap-like positional change. Lastly, and upon further revolution of rotational support member 40, and with reference to FIG. 3D, a fourth position is realized within chamber 22, wherein base 45 is again essentially perpendicular to peripheral wall 28, an opposingly positioned peripheral wall 28 relative to that of the second position described above and shown in FIG. 3B, and flap member 62 is extended between mount 48 and mount 49 in an angular fashion relative to peripheral walls 28.

The method of enhancing the flow of liquid according to preferred device 10 thus benefits from the generally resilient or slightly elastic conformation of flap member 62, wherein a snapping action may be realized as travel around the circumferential path continues for rotationally mounted support member 40 and resultingly enhanced movement of flap member 62 facilitates a flowing, supple motion thereof to direct liquid. Further, rotationally mounted support member 40 may be connected to a spin-drive delivery tool (not shown) in order to allow for high speed/fast pace movement thereof, wherein the level of enhancement to the flow of the liquid passing through device 10 may be generally controlled according to the pace of such a spin-drive.

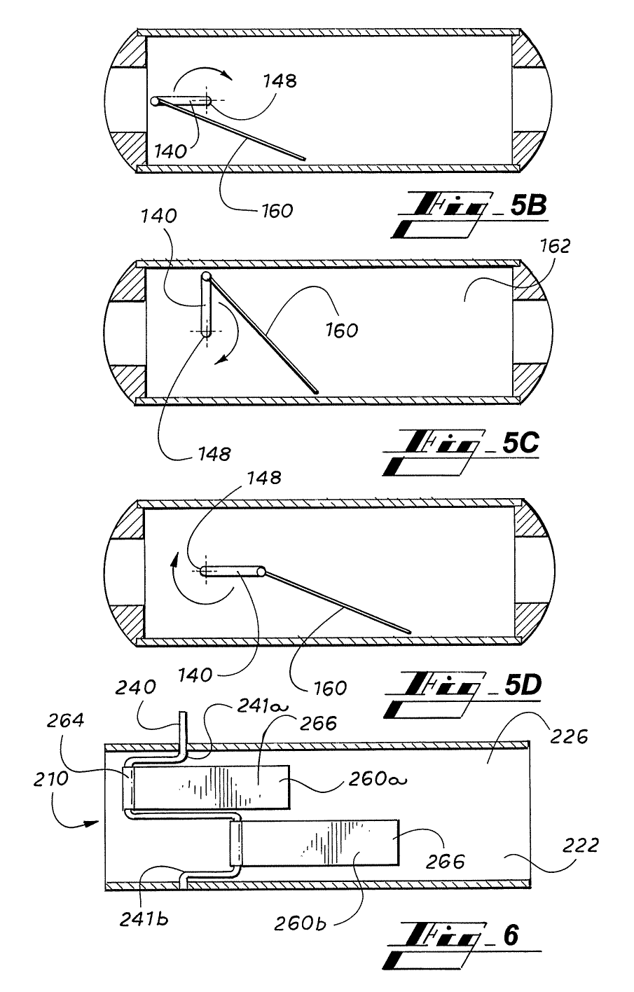

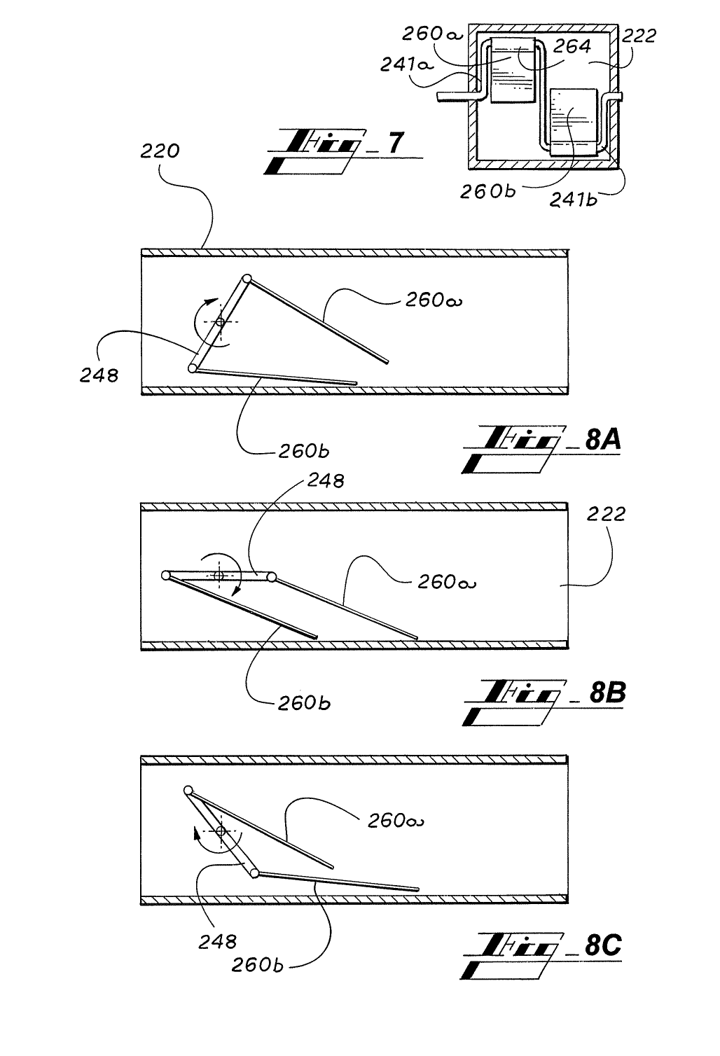

In another embodiment, pump device 110 could be formed without fixedly mounted support member 50 proximate out flow end 126. Referring now to FIGS. 4-5D, in such an embodiment, flap member 160 could be generally rigid plate 162, yet with slight flexibility, wherein rotation of U-shaped member 140 could direct first end 164 of plate-style flap member 160 along a circumferential path, but second end 166 would remain untethered within chamber 122, thereby allowing for a free, flipper/fin-type movement for enhancing the flow of fluid through chamber 122.

As with the preferred embodiment, housing 120 is prism-shaped, defining parallelepiped interior chamber 122, and any one of a plurality of endpieces may be adaptively attached to inflow end 124 and/or outflow end 126 of housing 120 in order to facilitate inline installation of pump 110 into essentially any desired system. With further similarity to the preferred embodiment, rotationally mounted support member 140 extends transversely across housing 120 proximate inflow end 124, defining U-shape 144 within housing interior chamber 122.

Accordingly, as rotationally mounted support member 140 is rotated, U-shape 144 directs first end 164 of flap member 162 to travel along a circumferential path centered about mount 148. It is this movement of flap member 162, proximate first end 164, that serves to initiate a free, flipper/fin type motion for flap member 162, which in turn serves to enhance the flow of liquid through chamber 122.

Accordingly, and with reference to FIG. 5A, for example, when U-shape 144 is rotated to a first position, base 145 is essentially perpendicular to peripheral wall 128, and flap member 162 is generally flat and extended in coplanar fashion relative to sidewalls 128. Upon continued advancement through a revolution of rotational support member 140, and with reference to FIG. 5B, a second position may be attained wherein base 145 is essentially parallel to peripheral wall 128, and wherein flap member 162 is positioned in an angular fashion relative to sidewalls 128. Upon further revolution of rotational support member 140, and with reference to FIG. 5C, a third position is achieved, wherein base 145 is again essentially perpendicular to sidewalls 128, and wherein flap member 162 is positioned in a more sharply angled fashion relative to sidewalls 128, such that second end 166 of flap member 162 is positioned just proximate sidewall 128, and wherein a flapping motion thereof is facilitated. Lastly, and upon further revolution of rotational support member 140, and with reference to FIG. 5D, a fourth position is realized within chamber 122, wherein base 145 is again essentially parallel to peripheral wall 128, and the angular positioning of flap member 162 is relaxed, encouraging, again, more fin-like movement thereof.

The method of enhancing the flow of liquid according to preferred device 110 thus benefits from the slightly resilient nature of generally rigid plate member 162, wherein a flipper action may be realized as travel around the circumferential path continues for rotationally mounted support member 140 and resultingly enhanced movement of flap member 162 facilitates liquid motion. Further, and again similarly to the preferred embodiment, rotationally mounted support member 140 may be connected to a spin-drive delivery tool (not shown) in order to allow for high speed/fast pace movement thereof, wherein the level of enhancement to the flow of the liquid passing through device 110 may be generally controlled according to the pace of such a spin-drive.

In still another embodiment, referring now to FIGS. 6-8C, pump device 210 could be formed without U-shaped rotational member 40, wherein alternate rotational member 240 could be defined by pair of interconnected and inversely related U-shapes 241a, 241b. In such an embodiment, two flap members 260a, 260b could be included, with one flap member 260a, 260b attached to each U-shape 241a, 241brespectively, of rotational member 240. As with the previous embodiment, second end 266 of each flap member 260a, 260bproximate outflow end 226 of chamber 222, would remain free. Therefore, upon direction via rotational member 240, first end 264 of each flap member 260a, 260b continues to travel about a circumferential track, but ends 264 of the two flap members 260a, 260b remain positioned 180° relative to one another. A collaborative flipper-kicking motion results from the movement of dual flap members 260a, 260bserving to enhance the flow of fluid through the housing.

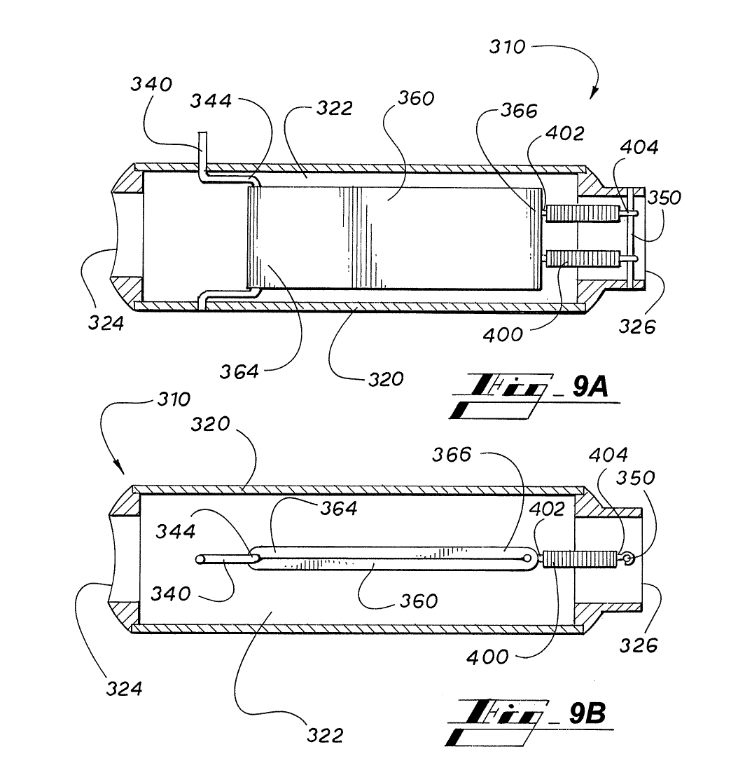

Accordingly, and with reference to FIG. 8A, for example, when dual U-shapes 241a, 241b are rotated to a first position, wherein base 245 of each is partially rotated to an angular position relative to sidewalls 220, flap member 260a is essentially angularly extended within interior chamber 222 and flap member 260b is essentially parallel relative to sidewall 220. Upon continued advancement through a revolution of U-shapes 241a, 241band with reference to FIG. 8B, a second position may be attained wherein each base 245 is essentially parallel to sidewalls 220, and wherein each flap member 260a, 260b is essentially transversely and angularly extended across approximately one-half of chamber 222, essentially parallel to one another. Upon further revolution, and with reference to FIG. 8C, a third position is achieved, wherein base 245 is again angularly positioned relative to sidewall 220, and wherein flap member 260a is essentially angularly extended within interior chamber 222 and flap member 260b is essentially parallel relative to sidewall 220. Because the angle of extension for each flap member 260a, 260b varies between positions, movement of flap members 260a, 260b facilitate the efficient continuation of the pump motion, as the rotational motion proceeds to direct flap members 262.

The method of enhancing the flow of liquid according to device 210 thus further benefits from the slightly resilient nature of generally rigid plate member 262, wherein a dual-flipper action may be realized as travel around the circumferential path continues and resultingly enhanced movement of flap members 260a, 260b facilitates liquid motion. Further, and again similarly to the preferred embodiment, rotationally mounted support member 240 may be connected to a spin-drive delivery tool (not shown) in order to allow for high speed/fast pace movement thereof, wherein the level of enhancement to the flow of the liquid passing through device 210 may be generally controlled according to the pace of such a spin-drive.

In still another embodiment, pump device 310 could be formed with alternate fixedly mounted support member 350 proximate out flow end 326. Referring now to FIGS. 9A-9B, in such an embodiment, second end 366 of flap member 360 could be secured to first end 402 of one or more springs 400, wherein second end 404 of each spring 400 is secured to alternate fixedly mounted support member 350. In such an embodiment, each spring 400 would be essentially coaxial with housing 320, and parallel with any other such spring 400 if more than one spring 400 is provided, wherein rotation of U-shaped member 340 could direct first end 364 of flap member 360 along a circumferential path, and resulting movement of second end 366 of flap member 360 would cause extension and permit retraction essentially to rest state for each spring 400, thereby enhancing the flow of fluid through chamber 322 by directing forces from each spring 400.

As with the preferred embodiment, housing 320 is prism-shaped, defining parallelepiped interior chamber 322, and any one of a plurality of endpieces may be adaptively attached to inflow end 324 and/or outflow end 326 of housing 320 in order to facilitate inline installation of pump 310 into essentially any desired system. With further similarity to the preferred embodiment, rotationally mounted support member 340 extends transversely across housing 320 proximate inflow end 324, defining U-shape 344 within housing interior chamber 322.

Accordingly, as rotationally mounted support member 340 is rotated, U-shape 344 directs first end 364 of flap member 362 to travel along a circumferential path centered about mount 348. It is this movement of flap member 360, proximate first end 364, that serves to initiate a flipper/fin type motion for flap member 360, coupled with an extension and retraction of spring 400, and enhances the flow of liquid through chamber 322.

The method of enhancing the flow of liquid according to alternate device 310 thus benefits from the resilient nature of spring 400, wherein spring energy is introduced to facilitate liquid motion. Further, and again similarly to the preferred embodiment, rotationally mounted support member 340 may be connected to a spin-drive delivery tool (not shown) in order to allow for high speed/fast pace movement thereof, wherein the level of enhancement to the flow of the liquid passing through device 310 may be generally controlled according to the pace of such a spin-drive.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A pump, comprising:
a fluid flow chamber with an inflow end and an outflow end;
one or more generally planar oscillating members; and
a crank rotationally carried by said fluid flow chamber proximate said inflow end and transversely oriented relative to the flow of fluid through said fluid flow chamber,
wherein said one or more generally planar oscillating members are carried by said crank, and wherein fluid flow through said chamber is enhanced by rotation of said crank and with attendant movement of said one or more generally planar oscillating members.

2. The pump of claim 1, wherein said fluid flow chamber is a generally rectangular, hollow housing

3. The pump of claim 2, wherein said housing further comprises at least one adaptive endpiece.

4. The pump of claim 1, wherein said crank defines a U-shaped member within said fluid flow member.

5. The pump of claim 4, further comprising a cross-support member fixedly carried by said fluid flow chamber proximate said outflow end, and extending transversely relative to the fluid flow through said fluid flow chamber.

6. The pump of claim 5, wherein said one or more flap members is a generally resilient and supple flap member with a first end and a second end, wherein said first end is carried by said crank and said second end is carried by said cross-support member.

7. The pump of claim 6, wherein the length of said flap member is greater than the distance between a point of intersection of said crank and said fluid flow member and a point of intersection of said cross-support member and said fluid flow member.

8. The pump of claim 1, further comprising a power drive for rotational motion of said crank.

9. The pump of claim 1, wherein said one or more flap members is one generally rigid plate with slight flexibility.

10. The pump of claim 1, wherein said crank further comprises a handle, said handle extending through an exterior wall of said fluid flow chamber.

11. The pump of claim 1, wherein said crank further comprises a pair of interconnected, inversely related U-shaped components.

12. The pump of claim 11, wherein said one or more generally planar members is two flap members, and wherein each said flap member is carried by one of said pair of interconnected, inversely related U-shaped components.

13. The pump of claim 12, wherein said movement of a first end of each said flap member is about a circumferential track, wherein each said first end of each said flap member is positioned 180° relative to said first end of each said other flap member.

14. The pump of claim 3, wherein said at least one adaptive endpiece is attached to said fluid flow chamber according to a means selected from the group consisting of friction fitted, welded, adhesively bonded, or threadedly related.

15. The pump of claim 1, wherein said one or more planar oscillating members has a width that extends transversely across an interior space of said fluid flow chamber.

16. The pump of claim 5, wherein said one or more flap members has a first end and a second end, wherein said first end of said one or more flap members is carried by said crank, and further comprising one or more springs having a proximal end and a distal end, wherein proximal end of said one or more springs is engaged with said second end of said one or more flap members, and wherein said distal end of said one ore more springs is carried by said cross-support member.

17. A method of enhancing fluid flow within a chamber, comprising the steps of:
adapting the chamber with a U-shaped crank transversely and rotationally carried within the chamber, a cross support bar transversely and fixed carried with the chamber, and a stretchy flap attached at a first end to said U-shaped crank and a second end to said cross support bar, wherein said stretchy flap has a length greater than the distance between said U-shaped crank and said cross support bar;
repeatedly rotating said U-shaped crank causing said first end of said stretchy flap to travel a path with the chamber,
wherein said path of said stretchy flap further comprises a position wherein said stretchy flap is slack between said U-shaped crank and said cross support bar,
wherein said path of said stretchy flap further comprises another position wherein said stretchy flap member is generally taught and angularly extended between said U-shaped crank and said cross support bar, and
wherein said path of said stretchy flap further comprises yet another position wherein said stretchy flap member is stretched and extended between said U-shaped crank and said cross support bar, and
allowing a snap-like movement of said stretchy flap to enhance fluid flow.

18. A method of enhancing fluid flow within a chamber, comprising the steps of:
adapting the chamber with a U-shaped crank transversely and rotationally carried within the chamber, and a plate attached at a first end to said U-shaped crank, wherein said plate is generally rigid with a slight flexibility;
repeatedly rotating said U-shaped crank causing said first end of said plate to travel a path with the chamber,
wherein said path of said plate further comprises a position wherein said plate is essentially parallel to the sidewalls of the chamber,
wherein said path of said plate further comprises another position wherein said plate is generally angularly related to the sidewalls of the chamber,
wherein said path of said plate further comprises yet another position wherein said plate is further angularly related to the sidewalls of the chamber, and
allowing a flipper fin-like movement of a second end of said plate to enhance fluid flow.

19. A method of enhancing fluid flow within a chamber, comprising the steps of:
adapting the chamber with a crank transversely and rotationally carried within the chamber, said crank comprising a pair of interconnected and inversely related U-shaped members, a first plate attached at a first end to a first said U-shaped member, and a second plate attached at a first end to a second said U-shaped member, wherein each said plate is generally rigid with a slight flexibility;
repeatedly rotating said crank causing said first ends of said plates to travel a path with the chamber, wherein said path of said first plate is 180° relative said path of said second plate;
wherein said path of each said plate further comprises a position wherein each said plate is essentially parallel to the sidewalls of the chamber,
wherein said path of each said plate further comprises another position wherein each said plate is generally angularly related to the sidewalls of the chamber,
wherein said path of each said plate further comprises yet another position wherein each said plate is further angularly related to the sidewalls of the chamber, and
allowing a collaborative flipper fin-like movement of a second end of each said plate to enhance fluid flow.
